(19) United States
(12) Patent Application Publication
(10) Pub. No.: US 2012/0201294 A1
(43) Pub. Date: Aug. 9, 2012

(54) METHODS FOR PARALLEL VIDEO ENCODING AND DECODING

(76) Inventors: Christopher A. Segall, Camas, WA (US); Jie Zhao, Camas, WA (US)

(21) Appl. No.: 13/502,012

(22) PCT Filed: Oct. 14, 2010
(86) PCT No.: PCT/JP2010/068541

§ 371 Date: Apr. 13, 2012

(30) Foreign Application Priority Data
Oct. 14, 2009 (US) 12579236

(51) Int. Cl. H04N 7/12

(52) U.S. Cl. 375/240.02; 375/E07.001

(57) ABSTRACT

Aspects of the present invention are related to methods and devices for parallel video encoding and decoding. Aspects can include a method for encoding a video frame of a video sequence in an encoder, comprising partitioning a frame of a video sequence into at least one reconstruction slice, thereby producing a first reconstruction slice, and partitioning said first reconstruction slice into a plurality of entropy slices, wherein a number of bins associated with each entropy slice in said plurality of entropy slices is less than or equal to a predefined number of bins.

### RELATED REFERENCES

This application is a continuation-in-part of U.S. patent application Ser. No. 12/058,301, entitled “Methods and Systems for Parallel Video Encoding and Decoding,” filed on Mar. 28, 2008, said application U.S. patent application Ser. No. 12/058,301 is hereby incorporated by reference herein, in its entirety.

### TECHNICAL FIELD

Embodiments of the present invention relate generally to video coding and, in particular, to methods for parallel video encoding and decoding.

### BACKGROUND ART

State-of-the-art video-coding methods and standards, for example H.264/MPEG-4 AVC (H.264/AVC), may provide higher coding efficiency than older methods and standards at the expense of higher complexity. Increasing quality requirements and resolution requirements on video coding methods and standards may also increase their complexity. Decoders that support parallel decoding may improve decoding speeds and reduce memory requirements. Additionally, advances in multi-core processors may make encoders and decoders that support parallel decoding desirable.

H.264/MPEG-4 AVC [Joint Video Team of ITU-T VCEG and ISO/IEC MPEG, “H.264: Advanced video coding for generic audiovisual services,” ITU-T Rec. H.264 and ISO/IEC 14496−10 (MPEG4-Part 10), November 2007], which is hereby incorporated by reference herein in its entirety, is a video codec (coder/decoder) specification that uses macroblock prediction followed by residual coding to reduce temporal and spatial redundancy in a video sequence for compression efficiency.

### SUMMARY OF INVENTION

Some embodiments of the present invention comprise methods for parallel entropy encoding and decoding of a video bitstream based on partitioning of data into entropy slices that may be entropy encoded and decoded independently.

In some embodiments of the present invention, a first portion and second portion of an input compressed-video bitstream may be entropy decoded independently. A block of samples of a video frame associated with the second portion of the input compressed-video bitstream may be reconstructed using decoded data from the first portion and the second portion. Thus, the reconstruction neighbor definition and the entropy decoding neighbor definition are not the same.

In some embodiments of the present invention, an encoder may partition input data into entropy slices. The encoder may entropy encode the entropy slices independently. The encoder may form a bitstream comprising entropy-slice headers each of which may indicate the location in the bitstream of the associated data for the entropy slice. In some embodiments of the present invention, a decoder may parse a received bitstream for entropy-slice headers, and the decoder may entropy decode a plurality of entropy slices according to a decoder-defined level of parallelism.

In some embodiments of the present invention, data may be multiplexed at a picture level to form entropy slices. In some embodiments, one, or more, entropy slices may correspond to prediction data, and one, or more, entropy slices may correspond to residual data. In alternative embodiments of the present invention, one, or more, entropy slices may correspond to each of a plurality of color planes.

In some embodiments of the present invention, a bitstream may be trans-coded to comprise entropy slices. In these embodiments, a received bitstream may be entropy decoded, a plurality of entropy slices may be constructed, and each of the entropy slices may be independently entropy encoded and written to a trans-coded bitstream with an associated entropy-slice header.

In some embodiments of the present invention, an encoder may partition a reconstruction slice into a plurality of entropy slices, wherein the number of bins associated with each entropy slice in the plurality of entropy slices does not exceed a predefined number of bins. In alternative embodiments of the present invention, an encoder may partition a reconstruction slice into a plurality of entropy slices, wherein the number of macroblocks associated with each entropy slice in the plurality of entropy slices does not exceed a predefined number of macroblocks. In yet alternative embodiments of the present invention, an encoder may partition a reconstruction slice into a plurality of entropy slices, wherein the number of bits associated with each entropy slice in the plurality of entropy slices does not exceed a predefined number of bits.

The foregoing and other objectives, features, and advantages of the invention will be more readily understood upon consideration of the following detailed description of the invention taken in conjunction with the accompanying drawings.

### BRIEF DESCRIPTION OF DRAWINGS

FIG. 1 is a picture showing an H.264/AVC video encoder (prior art);

FIG. 2 is a picture showing an H.264/AVC video decoder (prior art);

FIG. 3 is a picture showing an exemplary slice structure (prior art);

FIG. 4 is a picture showing an exemplary slice group structure (prior art);

FIG. 5 is a picture showing an exemplary slice partition according to embodiments of the present invention, wherein a picture may be partitioned in at least one reconstruction slice and a reconstruction slice may be partitioned into more than one entropy slice;

FIG. 6 is chart showing exemplary embodiments of the present invention comprising an entropy slice;

FIG. 7 is a chart showing exemplary embodiments of the present invention comprising parallel entropy decoding of multiple entropy slices followed by slice reconstruction;

FIG. 8 is a chart showing exemplary embodiments of the present invention comprising prediction data/residual data multiplexing at the picture level for entropy slice construction;

FIG. 9 is a chart showing exemplary embodiments of the present invention comprising color-plane multiplexing at the picture level for entropy slice construction;

FIG. 10 is a chart showing exemplary embodiments of the present invention comprising trans-coding a bitstream by entropy decoding, forming entropy slices and entropy encoding;

FIG. 11 is a chart showing exemplary embodiments of the present invention comprising partitioning a reconstruction slice into a plurality of entropy slices, wherein the number of bins associated with each entropy slice in the plurality of entropy slices does not exceed a predefined number of bins;

FIG. 12 is a chart showing exemplary embodiments of the present invention comprising partitioning a reconstruction slice into a plurality of entropy slices, wherein bins may be associated with an entropy slice until the number of bins in the entropy slice exceeds a threshold based on a predefined maximum number of bins;

FIG. 13 is a chart showing exemplary embodiments of the present invention comprising partitioning a reconstruction slice into a plurality of entropy slices, wherein the number of bins associated with each entropy slice in the plurality of entropy slices does not exceed a predefined number of bins and each reconstruction slice contains no more than a predefined number of macroblocks;

FIG. 14 is a chart showing exemplary embodiments of the present invention comprising partitioning a reconstruction slice into a plurality of entropy slices, wherein bins may be associated with an entropy slice until the number of bins in the entropy slice exceeds a threshold based on a predefined maximum number of bins and each reconstruction slice contains no more than a predefined number of macroblocks;

FIG. 15 is a chart showing exemplary embodiments of the present invention comprising partitioning a reconstruction slice into a plurality of entropy slices, wherein the number of bits associated with each entropy slice in the plurality of entropy slices does not exceed a predefined number of bits; and

FIG. 16 is a chart showing exemplary embodiments of the present invention comprising partitioning a reconstruction slice into a plurality of entropy slices, wherein bits may be associated with an entropy slice until the number of bits in the entropy slices exceeds a threshold based on a predefined maximum number of bits.

### DESCRIPTION OF EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

While any video coder/decoder (codec) that uses entropy encoding/decoding may be accommodated by embodiments of the present invention, exemplary embodiments of the present invention will be illustrated in relation to an H.264/AVC encoder and an H.264/AVC decoder. This is intended for illustration of embodiments of the present invention and not limitation.

State-of-the-art video-coding methods and standards, for example H.264/AVC, may provide higher coding efficiency than older methods and standards at the expense of higher complexity. Increasing quality requirements and resolution requirements on video coding methods and standards may also increase their complexity. Decoders that support parallel decoding may improve decoding speeds and reduce memory requirements. Additionally, advances in multi-core processors may make encoders and decoders that support parallel decoding desirable.

H.264/AVC, and many other video coding standards and methods, are based on a block-based hybrid video-coding approach, wherein the source-coding algorithm is a hybrid of inter-picture, also considered inter-frame, prediction, intra-picture, also considered intra-frame, prediction and transform coding of a prediction residual. Inter-frame prediction may exploit temporal redundancies, and intra-frame and transform coding of the prediction residual may exploit spatial redundancies.

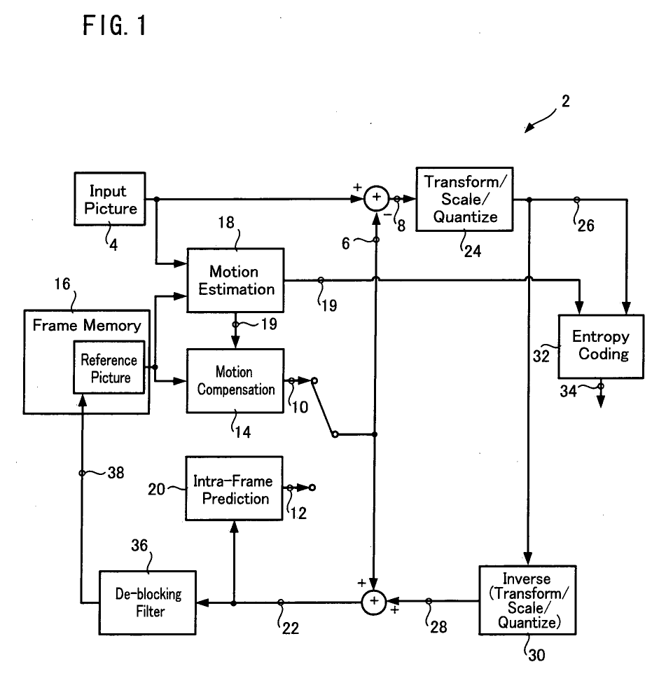

FIG. 1 shows a block diagram of an exemplary H.264/AVC video encoder 2. An input picture 4, also considered an input frame, may be presented for encoding. A predicted signal 6 and a residual signal 8 may be produced, wherein the predicted signal 6 may be based on either an inter-frame prediction 10 or an intra-frame prediction 12. The inter-frame prediction 10 may be determined by a motion compensating section 14 using (i) a reference picture stored in frame memory 16, also considered a reference frame, and (ii) motion information 19 determined by a motion estimation section 18 performing an estimation process for motion between the input frame (input picture) 4 and the reference frame (reference picture) 16. The intra-frame prediction 12 may be determined by intra-frame prediction section 20 using a decoded signal 22. The residual signal 8 may be determined by subtracting the prediction (predicted signal) 6 from the input frame 4. The residual signal 8 is transformed, scaled and quantized by transform/scale/quantize section 24, thereby producing quantized, transform coefficients 26. The decoded signal 22 may be generated by adding the predicted signal 6 to a signal 28 generated by an inverse (transform/scale/quantize) section 30 performing inverse transformation, scaling and inverse quantization of the quantized, transform coefficients 26. The motion information 19 and the quantized, transform coefficients 26 may be entropy coded by entropy coding section 32 and written to the compressed-video bitstream 34. An output image region 38, for example a portion of the reference frame, may be generated at the encoder 2, by a de-blocking filter section 36, through filtering the signal 22 that is reconstructed and is to be filtered.

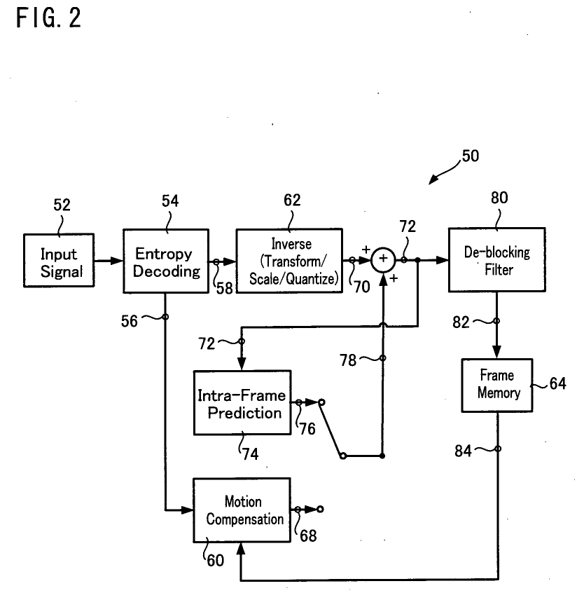

FIG. 2 shows a block diagram of an exemplary H.264/AVC video decoder 50. An input signal 52, also considered a bitstream, may be presented for decoding. Received symbols may be entropy decoded by entropy decoding section 54, thereby producing motion information 56 and quantized, scaled, transform coefficients 58. The motion information 56 may be combined by motion compensation section 60 with a portion of a reference frame 84 which may reside in frame memory 64, and an inter-frame prediction 68 may be generated. The quantized, scaled, transform coefficients 58 may be inversely quantized, scaled and inversely transformed by inverse (transform/scale/quantize) section 62, thereby producing a decoded residual signal 70. The residual signal 70 may be added to a prediction signal 78: either the inter-frame prediction signal 68 or an intra-frame prediction signal 76, and become combined signal 72. The intra-frame prediction signal 76 may be predicted by intra-frame prediction section 74 from previously decoded information (previously combined signal) 72 in the current frame. The combined signal 72 may be filtered by de-blocking filter section 80 and the filtered signal 82 may be written to frame memory 64.

In H.264/AVC, an input picture is partitioned into fixed-size macroblocks, wherein each macroblock covers a rectangular picture area of 16×16 samples of the luma component and 8×8 samples of each of the two chroma components. The decoding process of the H.264/AVC standard is specified for processing units which are macroblocks. The entropy decoding section 54 parses the syntax elements of the compressed-video bitstream 52 and de-multiplexes them. H.264/AVC specifies two alternative methods of entropy decoding: a low-complexity technique that is based on the usage of context-adaptively switched sets of variable length codes, referred to as CAVLC, and a computationally more demanding algorithm of context-based adaptively binary arithmetic coding, referred to as CABAC. In both entropy decoding methods, decoding of a current symbol may rely on previously, correctly decoded symbols and adaptively updated context models. In addition, different data information, for example, prediction data information, residual data information and different color planes, may be multiplexed together. De-multiplexing may not be done until elements are entropy decoded.

After entropy decoding, a macroblock may be reconstructed by obtaining: the residual signal through inverse quantization and the inverse transform, and the prediction signal, either the intra-frame prediction signal or the inter-frame prediction signal. Blocking distortion may be reduced by applying a de-blocking filter to every decoded macroblock. No processing may begin until the input signal is entropy decoded, thereby making entropy decoding a potential bottleneck in decoding.

Similarly, in codecs in which alternative prediction mechanisms may be allowed, for example, inter-layer prediction in H.264/AVC or inter-layer prediction in other scalable codecs, entropy decoding may be requisite prior to all processing at the decoder, thereby making entropy decoding a potential bottleneck.

In H.264/AVC, an input picture comprising a plurality of macroblocks may be partitioned into one or several slices. The values of the samples in the area of the picture that a slice represents may be correctly decoded without the use of data from other slices provided that the reference pictures used at the encoder and the decoder are identical. Therefore, entropy decoding and macroblock reconstruction for a slice do not depend on other slices. In particular, the entropy coding state is reset at the start of each slice. The data in other slices are marked as unavailable when defining neighborhood availability for both entropy decoding and reconstruction. In H.264/AVC, slices may be entropy decoded and reconstructed in parallel. No intra prediction and motion-vector prediction are allowed across the slice boundary. De-blocking filtering may use information across slice boundaries.

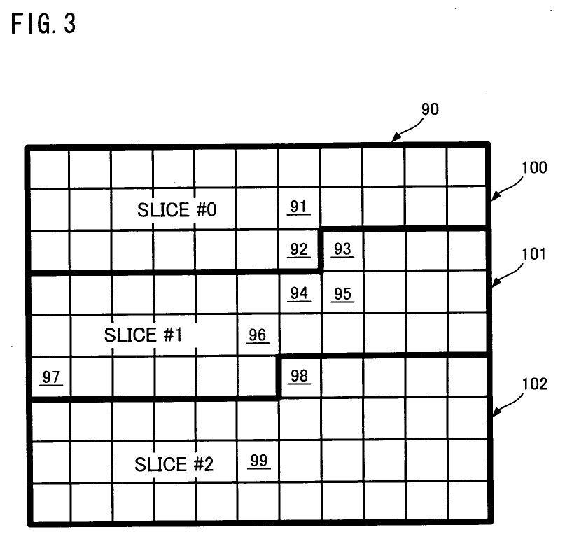

FIG. 3 shows an exemplary video picture 90 comprising eleven macroblocks in the horizontal direction and nine macroblocks in the vertical direction (nine exemplary macroblocks labeled 91-99). FIG. 3 shows three exemplary slices: a first slice denoted “SLICE #0” 100, a second slice denoted “SLICE #1” 101 and a third slice denoted “SLICE #2” 102. An H.264/AVC decoder may decode and reconstruct the three slices 100, 101, 102 in parallel. At the beginning of the decoding/reconstruction process for each slice, context models are initialized or reset and macroblocks in other slices are marked as unavailable for both entropy decoding and macroblock reconstruction. Thus, for a macroblock, for example, the macroblock labeled 93, in “SLICE #1,” macroblocks (for example, macroblocks labeled 91 and 92) in “SLICE #0” may not be used for context model selection or reconstruction. Whereas, for a macroblock, for example, the macroblock labeled 95, in “SLICE #1,” other macroblocks (for example, macroblocks labeled 93 and 94) in “SLICE #1” may be used for context model selection or reconstruction. Therefore, entropy decoding and macroblock reconstruction must proceed serially within a slice. Unless slices are defined using flexible macroblock ordering (FMO), macroblocks within a slice are processed in the order of a raster scan.

Flexible macroblock ordering defines a slice group to modify how a picture is partitioned into slices. The macroblocks in a slice group are defined by a macroblock-to-slice-group map, which is signaled by the content of the picture parameter set and additional information in the slice headers. The macroblock-to-slice-group map consists of a slice-group identification number for each macroblock in the picture. The slice-group identification number specifies to which slice group the associated macroblock belongs. Each slice group may be partitioned into one or more slices, wherein a slice is a sequence of macroblocks within the same slice group that is processed in the order of a raster scan within the set of macroblocks of a particular slice group. Entropy decoding and macroblock reconstruction must proceed serially within a slice.

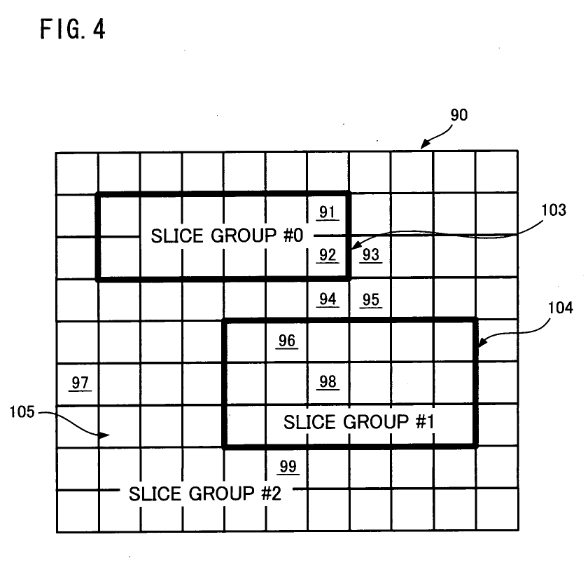

FIG. 4 depicts an exemplary macroblock allocation into three slice groups: a first slice group denoted “SLICE GROUP #0” 103, a second slice group denoted “SLICE GROUP #1” 104 and a third slice group denoted “SLICE GROUP #2” 105. These slice groups 103, 104, 105 may be associated with two foreground regions and a background region, respectively, in the picture 90.

Some embodiments of the present invention may comprise partitioning a picture into one or more reconstruction slices, wherein a reconstruction slice may be self-contained in the respect that values of the samples in the area of the picture that the reconstruction slice represents may be correctly reconstructed without use of data from other reconstruction slices, provided that the references pictures used are identical at the encoder and the decoder. All reconstructed macroblocks within a reconstruction slice may be available in the neighborhood definition for reconstruction.

Some embodiments of the present invention may comprise partitioning a reconstruction slice into more than one entropy slice, wherein an entropy slice may be self-contained in the respect that symbol values in the area of the picture that the entropy slice represents may be correctly entropy decoded without the use of data from other entropy slices. In some embodiments of the present invention, the entropy coding state may be reset at the decoding start of each entropy slice. In some embodiments of the present invention, the data in other entropy slices may be marked as unavailable when defining neighborhood availability for entropy decoding. In some embodiments of the present invention, macroblocks in other entropy slices may not be used in a current block's context model selection. In some embodiments of the present invention, the context models may be updated only within an entropy slice. In these embodiments of the present invention, each entropy decoder associated with an entropy slice may maintain its own set of context models. ITU Telecommunication Standardization Sector, Study Group 16-Contribution 405 entitled “Entropy slices for parallel entropy decoding,” April 2008, is hereby incorporated by reference herein in its entirety.

Some embodiments of the present invention may comprise CABAC encoding/decoding. The CABAC encoding process includes the following four elementary steps: binarization; context model selection; binary arithmetic coding; and probability update.

Binarization: A non-binary-valued symbol (for example, a transform coefficient, a motion vector, or other coding data) is converted into a binary code, also referred to as a bin string or a binarized symbol. When a binary-valued syntax element is given, the initial step of binarization may be bypassed. A binary-valued syntax element or an element of a binarized symbol may be referred to as a bin.

For each bin, the following may be performed:

Context Model Selection: A context model is a probability model for one or more bins. The context model comprises, for each bin, the probability of the bin being a “1” or a “0.” The model may be chosen for a selection of available models depending on the statistics of recently coded data symbols, usually based on the left and above neighboring symbols, if available.

Binary Arithmetic Coding: An arithmetic coder encodes each bin according to the selected probability model and is based on recursive interval subdivision.

Probability Update: The selected context model is updated based on the actual coded value.

In some embodiments of the present invention comprising CABAC encoding/decoding, at the decoding start of an entropy slice, all of the context models may be initialized or reset to predefined models.

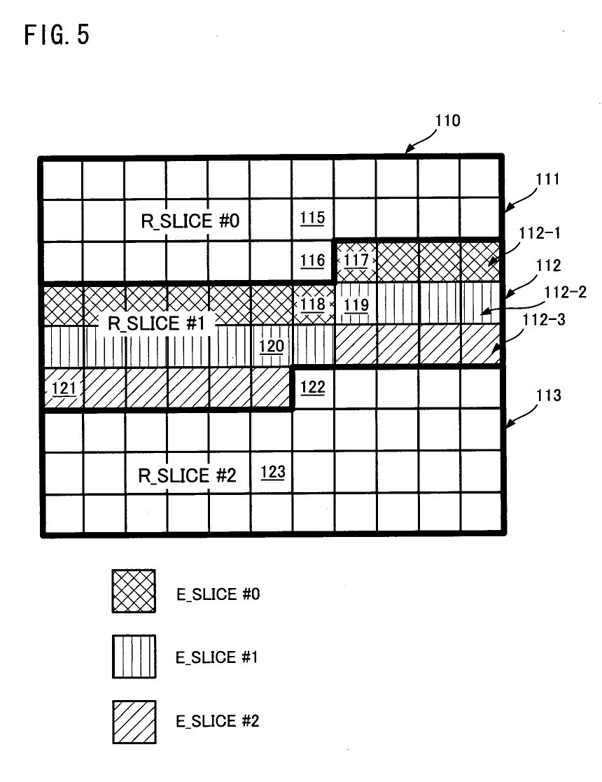

Some embodiments of the present invention may be understood in relation to FIG. 5. FIG. 5 shows an exemplary video frame 110 comprising eleven macroblocks in the horizontal direction and nine macroblocks in the vertical direction (nine exemplary macroblocks labeled 115-123). FIG. 5 shows three exemplary reconstruction slices: a first reconstruction slice denoted “R_SLICE #0” 111, a second reconstruction slice denoted “R_SLICE #1” 112 and a third reconstruction slice denoted “R_SLICE #2” 113. FIG. 5 further shows a partitioning of the second reconstruction slice “R_SLICE #1” 112 into three entropy slices: a first entropy slice denoted “E_SLICE #0” shown in cross-hatch 112-1, a second entropy slice denoted “E_SLICE #1” shown in vertical-hatch 112-2 and a third entropy slice denoted “E_SLICE #2” shown in angle-hatch 112-3. Each entropy slice 112-1, 112-2, 112-3 may be entropy decoded in parallel. Here, first entropy slice denoted “E_SLICE #0” and second entropy slice denoted “E_SLICE #1” may also be referred to as first portion and second portion of the bitstream.

In some embodiments of the present invention, only data from macroblocks within an entropy slice may be available for context model selection during entropy decoding of the entropy slice. All other macroblocks may be marked as unavailable. For this exemplary partitioning, macroblocks labeled 117 and 118 are unavailable for context model selection when decoding symbols corresponding to the area of macroblock labeled 119 because macroblocks labeled 117 and 118 are outside of the entropy slice containing macroblock 119. However, these macroblocks 117, 118 are available when macroblock 119 is reconstructed.

In some embodiments of the present invention, an encoder may determine whether or not to partition a reconstruction slice into entropy slices, and the encoder may signal the decision in the bitstream. In some embodiments of the present invention, the signal may comprise an entropy-slice flag, which may be denoted “entropy_slice_flag” in some embodiments of the present invention.

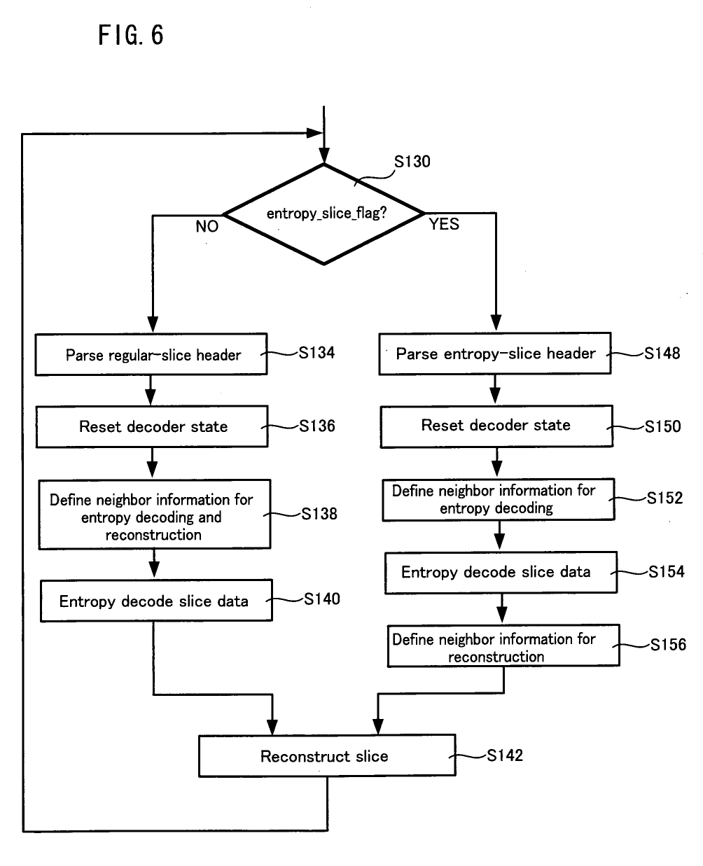

Some decoder embodiments of the present invention may be described in relation to FIG. 6. In these embodiments, an entropy-slice flag may be examined (S130), and if the entropy-slice flag indicates that there are no entropy slices associated with a picture, or a reconstruction slice (NO in the step S130), then the header may be parsed as a regular slice header (S134). The entropy decoder state may be reset (S136), and the neighbor information for the entropy decoding and the reconstruction may be defined (S138). The slice data may then be entropy decoded (S140), and the slice may be reconstructed (S142). If the entropy-slice flag indicates there are entropy slices associated with a picture (YES in the step S130), then the header may be parsed as an entropy-slice header (S148). The entropy decoder state may be reset (S150), the neighbor information for entropy decoding may be defined (S152) and the entropy-slice data may be entropy decoded (S154). The neighbor information for reconstruction may then be defined (S156), and the slice may be reconstructed (S142). After slice reconstruction in the step S142, the next slice, or picture, may be examined (back to the step S130).

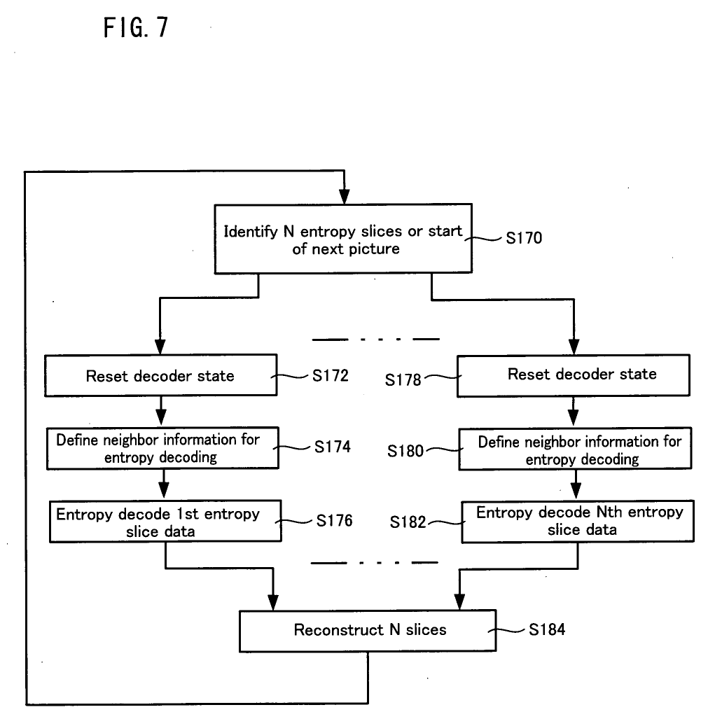

Some alternative decoder embodiments of the present invention may be described in relation to FIG. 7. In these embodiments, the decoder may be capable of parallel decoding and may define its own degree of parallelism, for example, consider a decoder comprising the capability of decoding N entropy slices in parallel. The decoder may identify N entropy slices (S170). In some embodiments of the present invention, if fewer than N entropy slices are available in the current picture, or reconstruction slice, the decoder may decode entropy slices from subsequent pictures, or reconstruction slices, if they are available. In alternative embodiments, the decoder may wait until the current picture, or reconstruction slice, is completely processed before decoding portions of a subsequent picture, or reconstruction slice. After identifying up to N entropy slices in the step of S170, each of the identified entropy slices may be independently entropy decoded. A first entropy slice may be decoded (S172-S176). The decoding of the first entropy slice may comprise resetting the decoder state (S172). In some embodiments comprising CABAC entropy decoding, the CABAC state may be reset. The neighbor information for the entropy decoding of the first entropy slice may be defined (S174), and the first entropy slice data may be decoded (S176). For each of the up to N entropy slices, these steps may be performed (S178-S182 for the Nth entropy slice). In some embodiments of the present invention, the decoder may reconstruct the entropy slices when all of the entropy slices are entropy decoded (S184). In alternative embodiments of the present invention, the decoder may begin reconstruction in the step of S184 after one or more entropy slices are decoded.

In some embodiments of the present invention, when there are more than N entropy slices, a decode thread may begin entropy decoding a next entropy slice upon the completion of entropy decoding of an entropy slice. Thus when a thread finishes entropy decoding a low complexity entropy slice, the thread may commence decoding additional entropy slices without waiting for other threads to finish their decoding.

In some embodiments of the present invention which may accommodate an existing standard or method, an entropy slice may share most of the slice attributes of a regular slice according to the standard or method. Therefore, an entropy slice may require a small header. In some embodiments of the present invention, the entropy slice header may allow a decoder to identify the start of an entropy slice and start entropy decoding. In some embodiments, at the start of a picture, or a reconstruction slice, the entropy slice header may be the regular header, or a reconstruction slice header.

In some embodiments of the present invention comprising an H.264/AVC codec, an entropy slice may be signaled by adding a new bit, “entropy_slice_flag” to the existing slice header. Table 1 lists the syntax for an entropy slice header according to embodiments of the present invention, wherein C indicates Category and Descriptor u(1), ue(v) indicate some fixed length or variable length coding methods. Embodiments of the present invention comprising an “entropy_slice_flag” may realize improved coding efficiency.

“first_mb_in_slice” specifies the address of the first macroblock in the entropy slice associated with the entropy-slice header. In some embodiments, the entropy slice may comprise a sequence of macroblocks.

“cabac_init_idc” specifies the index for determining the initialization table used in the initialization process for the context mode.

TABLE 1
Syntax Table for Entropy Slice Header

| slice_header( ) { | C | Descriptor |
|---|---|---|
| entropy_slice_flag | 2 | u(1) |
| if (entropy_slice_flag) { | | |
| first_mb_in_slice | 2 | ue(v) |
| if(entropy_coding_mode_flag&&slice_type!= | | |
| I && slice_type != SI) | | |
| cabac_init_idc | 2 | ue(v) |
| } | | |
| } | | |
| else { | | |
| a regular slice header ... | | |
| } | | |
| } | | |

In some embodiments of the present invention, an entropy slice may be assigned a different network abstraction layer (NAL) unit type from the regular slices. In these embodiments, a decoder may distinguish between regular slices and entropy slices based on the NAL unit type. In these embodiments, the bit field “entropy_slice_flag” is not required.

In some embodiments of the present invention, the bit field “entropy_slice_flag” may not be transmitted in all profiles. In some embodiments of the present invention, the bit field “entropy_slice_flag” may not be transmitted in a baseline profile, but the bit field “entropy_slice_flag” may be transmitted in higher profiles such as a main, an extended or a professional profile. In some embodiments of the present invention, the bit field “entropy_slice_flag” may only be transmitted in bitstreams associated with characteristics greater than a fixed characteristic value. Exemplary characteristics may include spatial resolution, frame rate, bit depth, bit rate and other bitstream characteristics. In some embodiments of the present invention, the bit field “entropy_slice_flag” may only be transmitted in bitstreams associated with spatial resolutions greater than 1920×1080 interlaced. In some embodiments of the present invention, the bit field “entropy_slice_flag” may only be transmitted in bitstreams associated with spatial resolutions greater than 1920×1080 progressive. In some embodiments of the present invention, if the bit field “entropy_slice_flag” is not transmitted, a default value may be used.

In some embodiments of the present invention, an entropy slice may be constructed by altering the data multiplexing. In some embodiments of the present invention, the group of symbols contained in an entropy slice may be multiplexed at the macroblock level. In alternative embodiments of the present invention, the group of symbols contained in an entropy slice may be multiplexed at the picture level. In other alternative embodiments of the present invention, the group of symbols contained in an entropy slice may be multiplexed by data type. In yet alternative embodiments of the present invention, the group of symbols contained in an entropy slice may be multiplexed in a combination of the above.

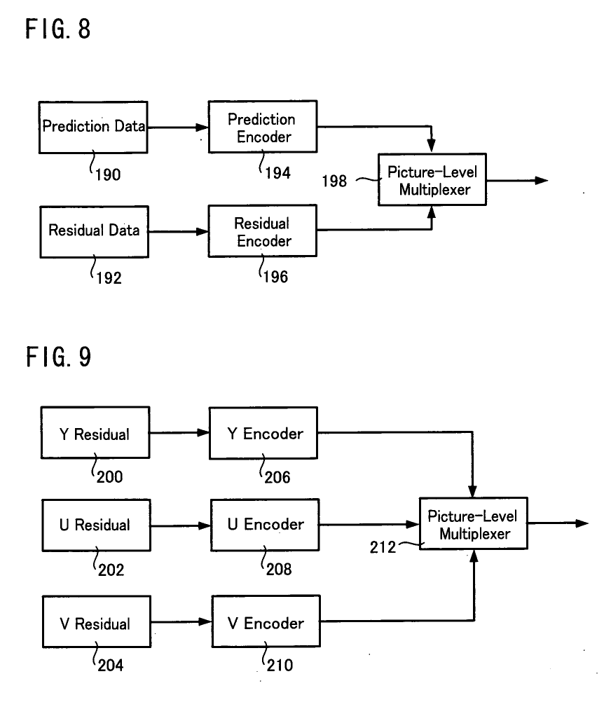

Some embodiments of the present invention comprising entropy slice construction based on picture level multiplexing may be understood in relation to FIG. 8 and FIG. 9. In some embodiments of the present invention shown in FIG. 8, prediction data 190 and residual data 192 may be entropy encoded by prediction encoder 194, and residual encoder 196 separately and multiplexed by picture-level multiplexer 198 at the picture level. In some embodiments of the present invention, the prediction data for a picture 190 may be associated with a first entropy slice, and the residual data for a picture 192 may be associated with a second entropy slice. The encoded prediction data and the encoded entropy data may be decoded in parallel. In some embodiments of the present invention, each partition comprising prediction data or residual data may be partitioned into entropy slices which may be decoded in parallel.

In some embodiments of the present invention shown in FIG. 9, the residual of each color plane, for example, the luma (Y) residual 200 and the two chroma (U and Y) residuals 202, 204, may be entropy encoded by Y encoder 206, U encoder 208, and V encoder 210 separately and multiplexed by picture-level multiplexer 212 at the picture level. In some embodiments of the present invention, the luma (Y) residual for a picture 200 may be associated with a first entropy slice, the first chroma (U) residual for a picture 202 may be associated with a second entropy slice, and the second chroma (V) residual for a picture 204 may be associated with a third entropy slice. The encoded residual data for the three color planes may be decoded in parallel. In some embodiments of the present invention, each partition comprising color-plane residual data may be partitioned into entropy slices which may be decoded in parallel. In some embodiments of the present invention, the luma residual 200 may have relatively more entropy slices compared to the chroma residuals 202, 204.

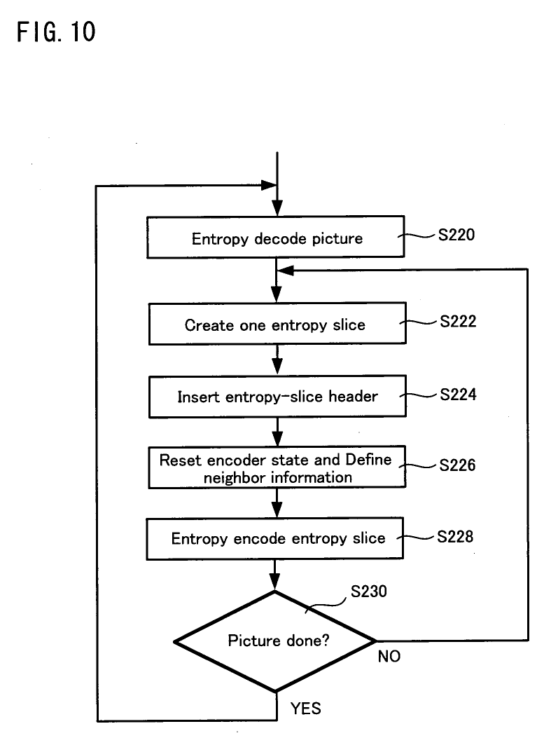

In some embodiments of the present invention, a compressed-video bitstream may be trans-coded to comprise entropy slices, thereby allowing for parallel entropy decoding as accommodated by embodiments of the present invention described above. Some embodiments of the present invention may be described in relation to FIG. 10. An input bitstream without entropy slices may be processed picture-by-picture according to FIG. 10. In these embodiments of the present invention, a picture from the input bitstream may be entropy decoded (S220). The data which had been coded, for example, mode data, motion information, residual information and other data, may be obtained. Entropy slices may be constructed one at a time from the data (S222). An entropy-slice header corresponding to an entropy slice may be inserted in a new bitstream (S224). The encoder state may be reset and the neighbor information may be defined (S226). The entropy slice may be entropy encoded 228 and written to the new bitstream. If there is picture data that has not been consumed by the constructed entropy slices (NO in the step S230), then another entropy slice may be constructed in the step of S222, and the process of S224-S230 may continue until all of the picture data has been consumed by the constructed entropy slices (YES in the step S230), and then the next picture may be processed.

As described above, in conventional techniques, macroblocks in other slices are not available for both entropy decoding and macroblock reconstruction. In contrast, some embodiments of the present invention differ from these conventional techniques, in the following point. In some embodiments of the present invention, only data from macroblocks within an entropy slice may be available for context model selection during entropy decoding of the entropy slice. However, a macroblock within a reconstruction slice may be reconstructed by using the other macroblocks within the reconstruction slice.

For this reason, by the invention according to the subject application, entropy slices are entropy encoded (decoded) in parallel (independently) and reconstructed by batch process, so that it is possible to perform the reconstruction by continuous prediction in reconstruction slices. With the invention according to the subject application, therefore, in reconstruction processing, prediction process is performed without the prediction process being interrupted at boundaries of the entropy slices (i.e. other entropy slice information is usable in the entropy slices). This enables parallel entropy processings while holding down the fall in coding efficiency.

In some embodiments of the present invention, an encoder may partition a reconstruction slice into a plurality of entropy slices in a similar way to that shown in FIG. 5, wherein the size of each entropy slice may be less than, or may not exceed, a fixed number of bins. In some embodiments wherein the encoder may restrict the size of each entropy slice, the maximum number of bins may be signaled in the bitstream. In alternative embodiments wherein the encoder may restrict the size of each entropy slice, the maximum number of bins may be defined by the profile and level conformance point of the encoder. For example, Annex A of the H.264/AVC video coding specification may be extended to comprise a definition of the maximum number of bins allowed in an entropy slice.

In some embodiments of the present invention, the maximum number of bins allowed in an entropy slice may be indicated for each level conformance point of the encoder according to a table, for example, as shown in Table 2, where M_{m.n} denotes the maximum number of bins allowed in an entropy slice for a level m.n conformance point.

TABLE 2
Maximum Number of Bins per Entropy Slice for Each Level

| | Maximum |
|---|---|
| | Number of Bins per |
| Level | Entropy Slice |
| 1.1 | M_{1.1} |
| 1.2 | M_{1.2} |
| . | . |
| . | . |
| . | . |
| m.n | M_{m.n} |
| . | . |
| . | . |
| . | . |
| 5.1 | M_{5.1} |

Some embodiments of the present invention may disclose methods in which the predefined size is associated with a level conformance point associated with the video bitstream.

Exemplary maximum number of bins allowed in an entropy slice are M_{1.1}=1,000 bins, M_{1.2}=2,000 bins, . . . , and M_{5.1}=40,000 bins. Other exemplary maximum number of bins allowed in an entropy slice are M_{1.1}=2,500 bins, M_{1.2}=4,200 bins, . . . , and M_{5.1}=150,000 bins.

In some embodiments, a set of maximum number of bins allowed in an entropy slice may be determined for all levels based on bit rate, image size, number of macroblocks and other encoding parameters. In some embodiments of the present invention the maximum number of bins allowed in an entropy slice may be the set to the same number for all levels. Exemplary values are 38,000 bins and 120,000 bins.

In some embodiments of the present invention, an encoder may determine a worst case number of bins associated with a macroblock, and the encoder may write the bins associated with:

$$\frac{ESLICE\_MaxNumberBins}{BinsPerMB} ,$$

macroblocks to each entropy slice, where ESLICE_MaxNumberBins may denote the maximum number of bins allowed in an entropy slice and BinsPerMB may denote the worst case number of bins associated with a macroblock. In some embodiments, the macroblocks may be selected in raster-scan order. In alternative embodiments, the macroblocks may be selected in another, predefined order. In some embodiments, the worst case number of bins associated with a macroblock may be a fixed number. In alternative embodiments, the encoder may update the worst case number based on measurements of the sizes of previously processed macroblocks.

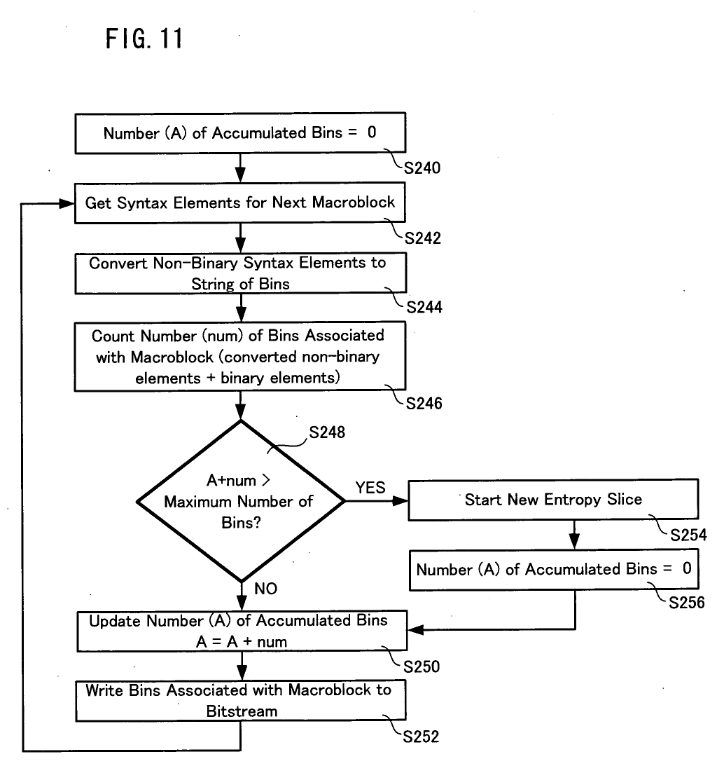

Some embodiments of the present invention may be described in relation to FIG. 11. In these embodiments, an encoder may, for a reconstruction slice, partition the reconstruction slice into a plurality of entropy slices wherein no entropy slice may be larger in size than a predetermined (predefined) number of bins. The encoder may initialize to zero a counter associated with the number of bins in a current entropy slice (S240). The counter value may be denoted A for illustrative purposes in the remainder of the description of the embodiments of the present invention described in relation to FIG. 11. The syntax elements for a next macroblock may be obtained (S242). The next macroblock may be determined according to a predefined macroblock processing order. In some embodiments, the macroblock processing order may correspond to a raster-scan ordering. Non-binary syntax elements in the macroblock may be converted to a string of bins (S244). Binary syntax elements may not require conversion. The number of bins associated with the macroblock may be determined (S246). The number of bins associated with the macroblock may include the bins in the strings of bins associated with the non-binary syntax elements in addition to the binary syntax elements, and the number of bins associated with the macroblock may be denoted num for illustrative purposes in the remainder of the description of the embodiments of the present invention described in relation to FIG. 11.

The encoder may determine whether or not a sum of the number of bins associated with the macroblock and the number of already accumulated bins associated with the current entropy slice is greater than a maximum number of bins allowed for an entropy slice (S248). In the step S248, if the number of bins associated with the macroblock may be added to the number of already accumulated bins associated with the current entropy slice without (NO in the step S248) exceeding the maximum number of bins allowed for an entropy slice, then the number of accumulated bins associated with the current entropy slice may be updated to include the bins associated with the macroblock (S250), and the bins associated with the macroblock may be written, by the entropy encoder, to the bitstream (S252) and associated with the current entropy slice. The syntax elements for the next macroblock may be obtained (back to the step S242), and the partitioning process may continue.

In the step S248, if the sum of the number of bins associated with the macroblock and the number of already accumulated bins associated with the current entropy slice exceeds the maximum number of bins allowed for an entropy slice (YES in the S248), then the encoder may start a new entropy slice associated with the current reconstruction slice (S254), and the counter associated with the number of bins in the current entropy slice may be initialized to zero (S256). The number of accumulated bins associated with the current entropy slice may be updated to include the bins associated with the macroblock (S250), and the bins associated with the macroblock may be written, by the entropy encoder, to the bitstream and associated with the current entropy slice (S252). The syntax elements for the next macroblock may be obtained (back to the step S242), and the partitioning process may continue.

As described above, in some embodiments of the present invention, a reconstruction slice is partitioned into entropy slices. With the entropy slices, the entropy encode (decode) processing is performed independently per slice, and in a reconstruction processing, information of other entropy slices is usable. Additionally, the present invention includes the technique in which (i) a frame can be portioned into slices, based on the number of bins, and (ii) the number of bins is arranged variable according to a level. As a result, the fall in coding efficiency caused by achieving the parallel entropy processing is held down to its least degree.

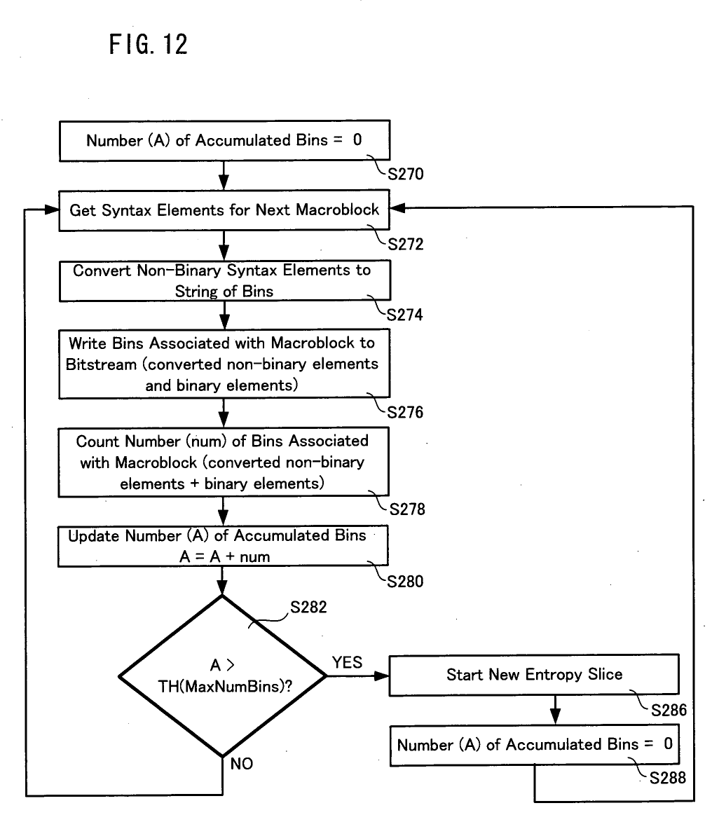

Some embodiments of the present invention may be described in relation to FIG. 12. In these embodiments, an encoder may, for a reconstruction slice, partition the reconstruction slice into a plurality of entropy slices wherein no entropy slice may be larger in size than a predetermined maximum (predefined) number of bins. In these embodiments, the encoder may associate macroblock syntax elements with an entropy slice until the size of the entropy slice reaches a threshold associated with the predetermined maximum number of bins allowed in an entropy slice. In some embodiments, the threshold may be a percentage of the maximum number of bins allowed in an entropy slice. In one exemplary embodiment, the threshold may be 90% of the maximum number of bins allowed in an entropy slice, supposing that the greatest number of bins expected in a macroblock is less than 10% of the maximum number of bins. In another exemplary embodiment, the threshold may be a percentage of the maximum number of bins allowed in an entropy slice wherein the percentage may be based on the greatest number of bins expected in a macroblock. In these embodiments, once the size of an entropy slice exceeds a threshold size, then another entropy slice may be created. The threshold size may be selected to ensure that the entropy slice does not exceed the maximum number of bins allowed in an entropy slice. In some embodiments, the threshold size may be a function of the maximum number of bins allowed in an entropy slice and an estimate of the maximum number of bins expected for a macroblock.

The encoder may initialize to zero a counter associated with the number of bins in a current entropy slice (S270). The counter value may be denoted A for illustrative purposes in the remainder of the description of the embodiments of the present invention described in relation to FIG. 12. The syntax elements for a next macroblock may be obtained (S272). The next macroblock may be determined according to a predefined macroblock processing order. In some embodiments, the macroblock processing order may correspond to a raster-scan ordering. Non-binary syntax elements in the macroblock may be converted to a string of bins (S274). Binary syntax elements may not require conversion. The bins associated with the macroblock may be written, by the entropy encoder, to the bitstream and associated with the current entropy slice (S276). The number of bins associated with the macroblock may be determined (S278), and the number of accumulated bins associated with the current entropy slice may be updated to include the bins associated with the macroblock (S280). If the number of accumulated bins associated with the current entropy slice is greater than the threshold (S282), which may be denoted TH(MaxNumBins), based on the maximum number of bins allowed in an entropy slice (YES in the step S282), then the encoder may start a new entropy slice (S286), and initialize to zero the counter associated with the number of bins in a current entropy slice (S288). The syntax elements for the next macroblock may be obtained (back to the step S272), and the partitioning process may continue. If the number of accumulated bins associated with the current entropy slice is not greater than the threshold based on the maximum number of bins allowed in an entropy slice (NO in the step S282), then the syntax elements for the next macroblock may be obtained (back to the step S272), and the partitioning process may continue.

In some embodiments of the present invention, an encoder may start a new reconstruction slice when a predetermined number of macroblocks have been assigned to the current reconstruction slice.

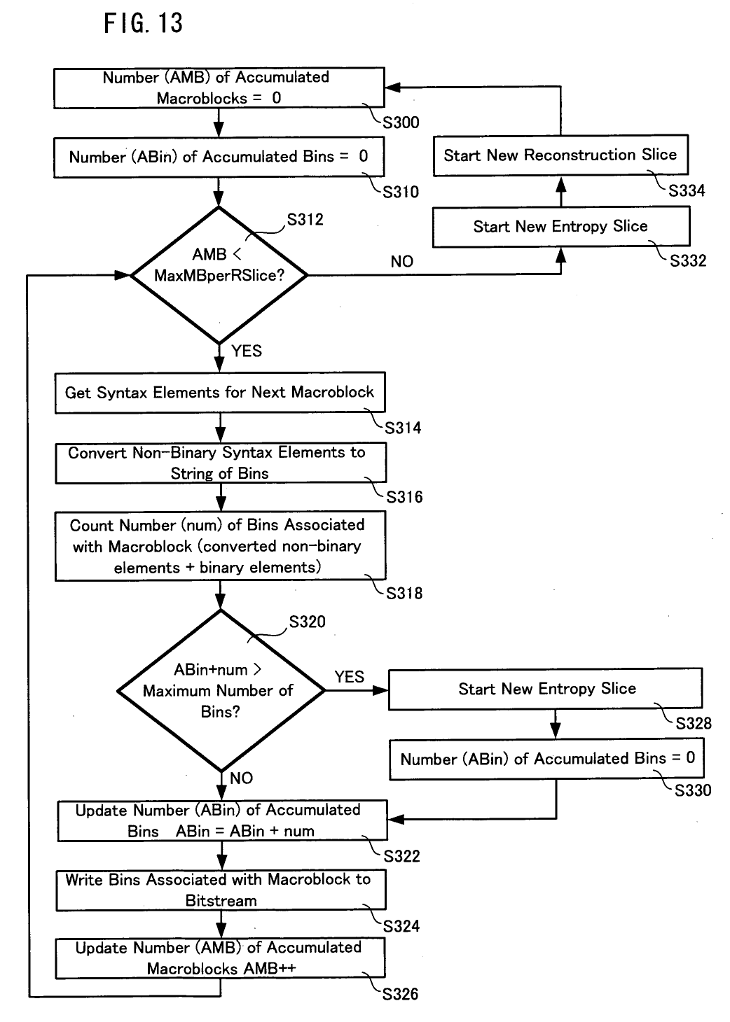

Some embodiments of the present invention may be described in relation to FIG. 13. In these embodiments, an encoder may start a new reconstruction slice when a predetermined number of macroblocks have been assigned to the current reconstruction slice. The encoder may initialize to zero a counter associated with the number of macroblocks in a current reconstruction slice (S300). The counter value may be denoted AMB for illustrative purposes in the remainder of the description of the embodiments of the present invention described in relation to FIG. 13. The encoder may initialize to zero a counter associated with the number of bins in a current entropy slice (S310). The counter value may be denoted ABin for illustrative purposes in the remainder of the description of the embodiments of the present invention described in relation to FIG. 13. If the counter value of the counter associated with the number of macroblocks in the current reconstruction slice is not less than a predetermined maximum (predefined) number of macroblocks allowed in a reconstruction slice (NO in the step S312), then a new entropy slice may be started (S332), and a new reconstruction slice may be started (S334). The maximum number of macroblocks allowed in a reconstruction slice may be denoted MaxMBperRSlice for illustrative purposes in the remainder of the description of the embodiments of the present invention described in relation to FIG. 13.

If the counter value of the counter associated with the number of macroblocks in the current reconstruction slice is less than the predetermined maximum number of macroblocks allowed in a reconstruction slice (YES in the step S312), then the syntax elements for a next macroblock may be obtained (S314). The next macroblock may be determined according to a predefined macroblock processing order. In some embodiments, the macroblock processing order may correspond to a raster-scan ordering. Non-binary syntax elements in the macroblock may be converted to a string of bins (S316). Binary syntax elements may not require conversion. The number of bins associated with the macroblock may be determined (S318). The number of bins associated with the macroblock may include the bins in the strings of bins associated with the non-binary syntax elements in addition to the binary syntax elements, and the number of bins associated with the macroblock may be denoted num for illustrative purposes in the remainder of the description of the embodiments of the present invention described in relation to FIG. 13.

The encoder may determine whether or not a sum of the number of bins associated with the macroblock and the number of already accumulated bins associated with the current entropy slice is greater than a maximum number of bins allowed for an entropy slice (S320). In the step S320 if the number of bins associated with the macroblock may be added to the number of already accumulated bins associated with the current entropy slice without exceeding a maximum number of bins allowed for an entropy slice (NO in the step S320), then the number of accumulated bins associated with the current entropy slice may be updated to include the bins associated with the macroblock (S322), the bins associated with the macroblock may be written, by the entropy encoder, to the bitstream and associated with the current entropy slice (S324), and the number of macroblocks associated with the current reconstruction slice may be incremented (S326). The number of macroblocks associated with the current reconstruction slice may be compared to the predetermined maximum number of macroblocks allowed in a reconstruction slice (back to the step S312), and the partitioning process may continue.

In the step S320, if the sum of the number of bins associated with the macroblock and the number of already accumulated bins associated with the current entropy slice exceeds the maximum number of bins allowed for an entropy slice (YES in the step S320), then the encoder may start a new entropy slice associated with the current reconstruction slice (S328), and the counter associated with the number of bins in the current entropy slice may be initialized to zero (S 330). The number of accumulated bins associated with the current entropy slice may be updated to include the bins associated with the macroblock (S322), the bins associated with the macroblock may be written, by the entropy encoder, to the bitstream and associated with the current entropy slice (S324), and the number of macroblocks associated with the current reconstruction slice may be incremented (S326). The number of macroblocks associated with the current reconstruction slice may be compared to the predetermined maximum number of macroblocks allowed in a reconstruction slice (back to the step 312), and the partitioning process may continue.

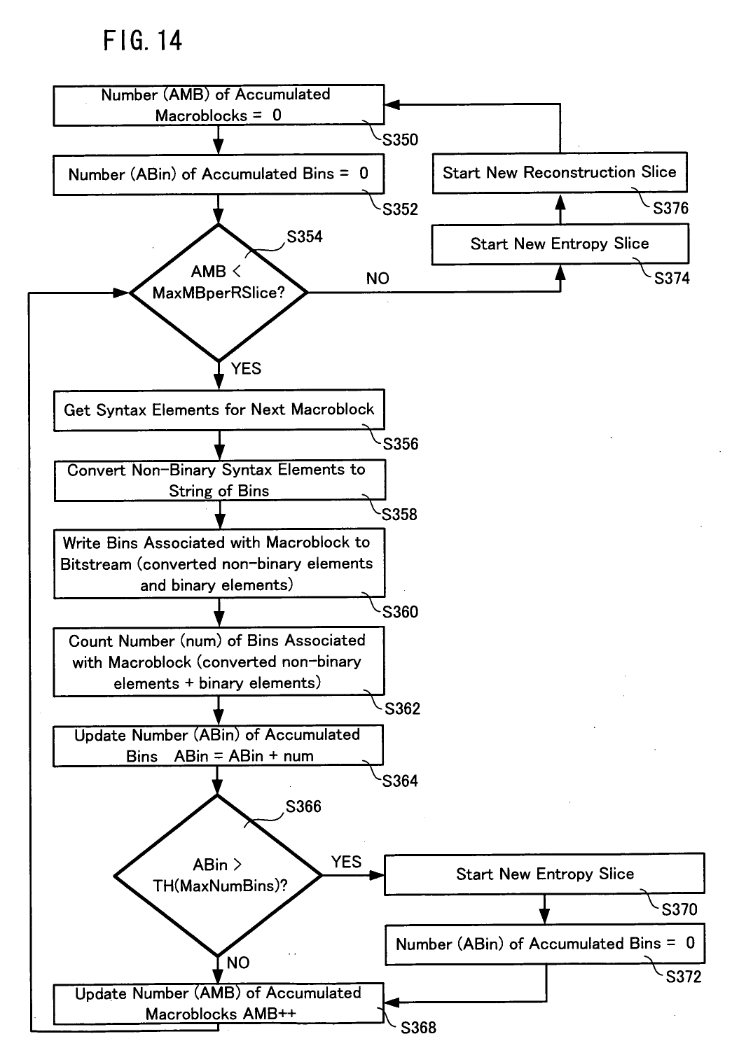

Some embodiments of the present invention may be described in relation to FIG. 14. In these embodiments, an encoder may start a new reconstruction slice when a predetermined number of macroblocks have been assigned to the current reconstruction slice. In these embodiments, the encoder may associate macroblock syntax elements with an entropy slice until the size of the entropy slice reaches a threshold associated with the predetermined maximum number of bins allowed in an entropy slice. In some embodiments, the threshold may be a percentage of the maximum number of bins allowed in an entropy slice. In one exemplary embodiment, the threshold may be 90% of the maximum number of bins allowed in an entropy slice, supposing that the greatest number of bins expected in a macroblock is less than 10% of the maximum number of bins. In another exemplary embodiment, the threshold may be a percentage of the maximum number of bins allowed in an entropy slice wherein the percentage may be based on the greatest number of bins expected in a macroblock. In these embodiments, once the size of an entropy slice exceeds a threshold size, then another entropy slice may be created. The threshold size may be selected to ensure that the entropy slice does not exceed the maximum number of bins allowed in an entropy slice. In some embodiments, the threshold size may be a function of the maximum number of bins allowed in an entropy slice and an estimate of the maximum number of bins expected for a macroblock.

The encoder may initialize to zero a counter associated with the number of macroblocks in a current reconstruction slice (S350). The counter value may be denoted AMB for illustrative purposes in the remainder of the description of the embodiments of the present invention described in relation to FIG. 14. The encoder may initialize to zero a counter associated with the number of bins in a current entropy slice (S352). The counter value may be denoted ABin for illustrative purposes in the remainder of the description of the embodiments of the present invention described in relation to FIG. 14. If the counter value of the counter associated with the number of macroblocks in the current reconstruction slice is not less than a predetermined maximum number of macroblocks allowed in a reconstruction slice (NO in the step S354), then a new entropy slice may be started (S374), and a new reconstruction slice may be started (S376). The maximum number of macroblocks allowed in a reconstruction slice may be denoted MaxMBperRSlice for illustrative purposes in the remainder of the description of the embodiments of the present invention described in relation to FIG. 14.

If the counter value of the counter associated with the number of macroblocks in the current reconstruction slice is less than the predetermined maximum number of macroblocks allowed in a reconstruction slice (YES in the step S354), then the syntax elements for a next macroblock may be obtained (S356). The next macroblock may be determined according to a predefined macroblock processing order. In some embodiments, the macroblock processing order may correspond to a raster-scan ordering. Non-binary syntax elements in the macroblock may be converted to a string of bins (S358). Binary syntax elements may not require conversion. The bins associated with the macroblock may be written, by the entropy encoder, to the bitstream and associated with the current entropy slice (S360). The number of bins associated with the macroblock may be determined (S362), and the number of accumulated bins associated with the current entropy slice may be updated to include the bins associated with the macroblock (S364). If the number of accumulated bins associated with the current entropy slice is greater than a threshold (S366), which may be denoted TH(MaxNumBins), based on the maximum number of bins allowed in an entropy slice (YES in the step S366), then the encoder may start a new entropy slice (S370), and initialize to zero the counter associated with the number of bins in a current entropy slice (S372). The number of macroblocks associated with the current reconstruction slice may be incremented (S368). The number of macroblocks associated with the current reconstruction slice may be compared to the predetermined maximum number of macroblocks allowed in a reconstruction slice (back to the step S354), and the partitioning process may continue. If the number of accumulated bins associated with the current entropy slice is not greater than the threshold based on the maximum number of bins allowed in an entropy slice (NO in the step S366), then the number of macroblocks associated with the current reconstruction slice may be incremented (S368), and the number of macroblocks associated with the current reconstruction slice may be compared to the predetermined maximum number of macroblocks allowed in a reconstruction slice (back to the step S354), and the partitioning process may continue.

In alternative embodiments of the present invention, an encoder may partition a reconstruction slice into a plurality of entropy slices, wherein each entropy slice may be associated with no more than a predefined number of bits.

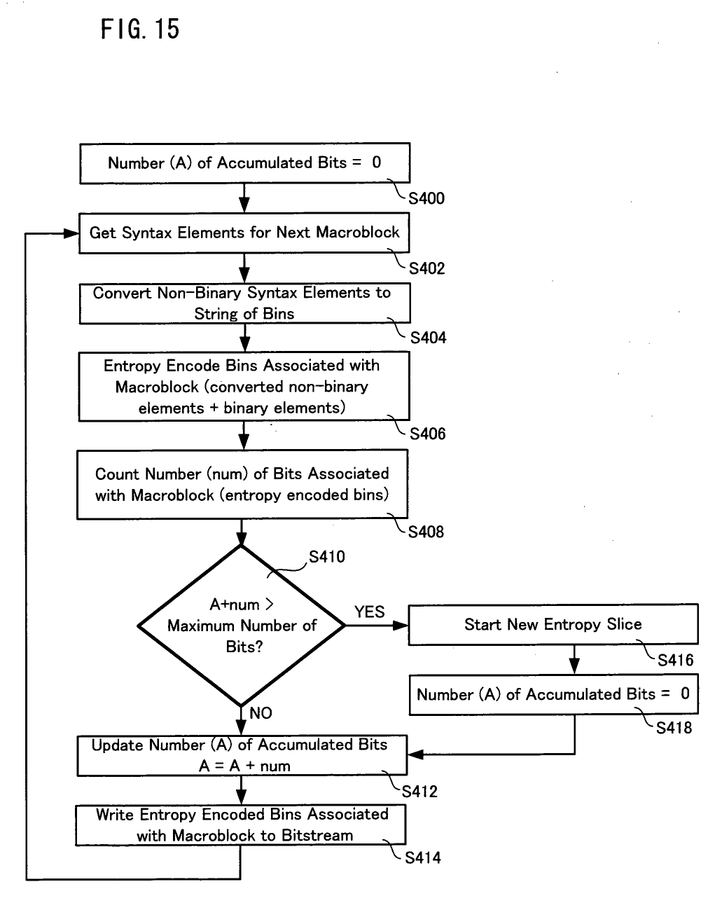

Some embodiments of the present invention may be described in relation to FIG. 15. In these embodiments, an encoder may, for a reconstruction slice, partition the reconstruction slice into a plurality of entropy slices wherein no entropy slice may be larger in size than a predetermined (predefined) number of bits. The encoder may initialize to zero a counter associated with the number of bits in a current entropy slice (S400). The counter value may be denoted A for illustrative purposes in the remainder of the description of the embodiments of the present invention described in relation to FIG. 15. The syntax elements for a next macroblock may be obtained (S402). The next macroblock may be determined according to a predefined macroblock processing order. In some embodiments, the macroblock processing order may correspond to a raster-scan ordering. Non-binary syntax elements in the macroblock may be converted to a string of bins (S404). Binary syntax elements may not require conversion. The bins, converted non-binary elements and binary elements, associated with the macroblock may be presented to the entropy encoder, and the bins may be entropy encoded (S406). The number of bits associated with the macroblock may be determined (S408). The number of bits associated with the macroblock may be denoted num for illustrative purposes in the remainder of the description of the embodiments of the present invention described in relation to FIG. 15.

The encoder may determine whether or not a sum of the number of bits associated with the macroblock and the number of already accumulated bits associated with the current entropy slice is greater than a maximum number of bits allowed for an entropy slice (S410). In the step S410, if the number of bits associated with the macroblock may be added to the number of already accumulated bits associated with the current entropy slice without exceeding the maximum number of bits allowed for an entropy slice (NO in the step S410), then the number of accumulated bits associated with the current entropy slice may be updated to include the bits associated with the macroblock (S412), and the bits associated with the macroblock may be written to the bitstream and associated with the current entropy slice (S414). The syntax elements for the next macroblock may be obtained (back to the step S402), and the partitioning process may continue.

In the step 410, if the sum of the number of bits associated with the macroblock and the number of already accumulated bits associated with the current entropy slice exceeds the maximum number of bits allowed for an entropy slice (YES in the step S410), then the encoder may start a new entropy slice associated with the current reconstruction slice (S416), and the counter associated with the number of bits in the current entropy slice may be initialized to zero (S418). The number of accumulated bits associated with the current entropy slice may be updated to include the bits associated with the macroblock (S412), and the bits associated with the macroblock may be written to the bitstream and associated with the current entropy slice (S414). The syntax elements for the next macroblock may be obtained (back to the step S402), and the partitioning process may continue.

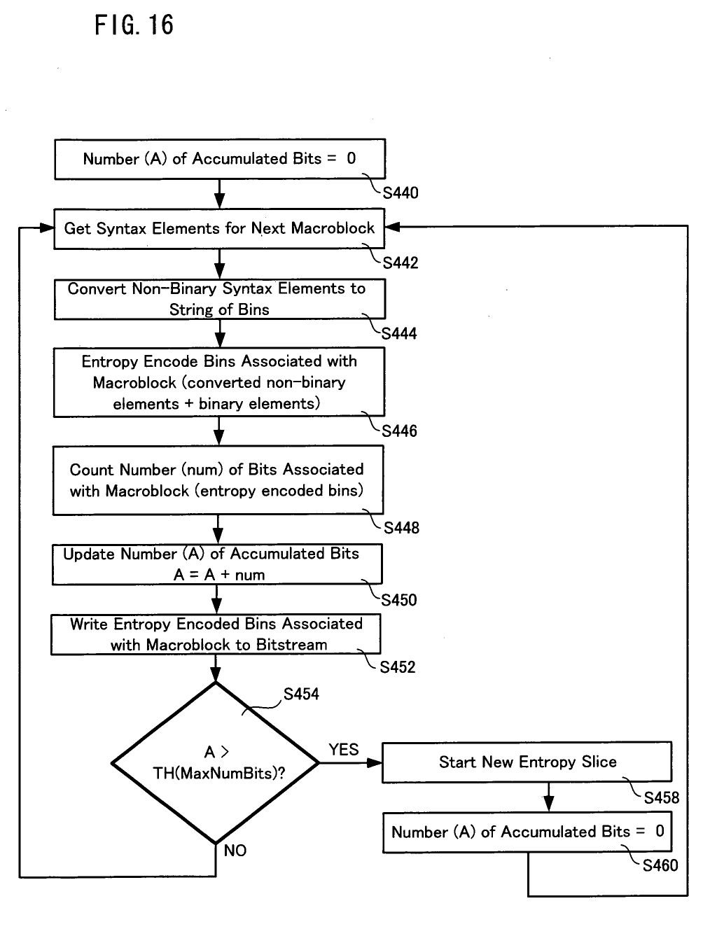

Some embodiments of the present invention may be described in relation to FIG. 16. In these embodiments, an encoder may, for a reconstruction slice, partition the reconstruction slice into a plurality of entropy slices wherein no entropy slice may be larger in size than a predetermined maximum number of bits. In these embodiments, the encoder may associate macroblock syntax elements with an entropy slice until the size of the entropy slice reaches a threshold associated with the predetermined maximum number of bits allowed in an entropy slice. In some embodiments, the threshold may be a percentage of the maximum number of bits allowed in an entropy slice. In one exemplary embodiment, the threshold may be 90% of the maximum number of bits allowed in an entropy slice, supposing that the greatest number of bits expected in a macroblock is less than 10% of the maximum number of bits. In another exemplary embodiment, the threshold may be a percentage of the maximum number of bits allowed in an entropy slice wherein the percentage may be based on the greatest number of bits expected in a macroblock. In these embodiments, once the size of an entropy slice exceeds a threshold size, then another entropy slice may be created. The threshold size may be selected to ensure that the entropy slice does not exceed the maximum number of bits allowed in an entropy slice. In some embodiments, the threshold size may be a function of the maximum number of bits allowed in an entropy slice and an estimate of the maximum number of bits expected for a macroblock.

The encoder may initialize to zero a counter associated with the number of bits in a current entropy slice (S440). The counter value may be denoted A for illustrative purposes in the remainder of the description of the embodiments of the present invention described in relation to FIG. 16. The syntax elements for a next macroblock may be obtained (S442). The next macroblock may be determined according to a predefined macroblock processing order. In some embodiments, the macroblock processing order may correspond to a raster-scan ordering. Non-binary syntax elements in the macroblock may be converted to a string of bins (S444). Binary syntax elements may not require conversion. The bins associated with the macroblock may be entropy encoded (S446), and the number of bins associated with the macroblock may be determined (S448). The number of accumulated bits associated with the current entropy slice may be updated to include the bins associated with the macroblock (S450), and the entropy encoded bins associated with the macroblock may be written to the bitstream (S452). If the number of accumulated bits associated with the current entropy slice is greater than a threshold (S454) based on the maximum number of bits allowed in an entropy slice (YES in the step S454), then the encoder may start a new entropy slice (S458), and initialize to zero the counter associated with the number of bits in a current entropy slice (S460). The syntax elements for the next macroblock may be obtained (back to the step S442), and the partitioning process may continue. If the number of accumulated bits associated with the current entropy slice is not greater than a threshold (S454) based on the maximum number of bits allowed in an entropy slice (NO in the step S454), then the syntax elements for the next macroblock may be obtained (back to the step 442), and the partitioning process may continue.

In alternative embodiments of the present invention, an encoder may partition a reconstruction slice into a plurality of entropy slices, wherein each entropy slice may be associated with no more than a predefined number of macroblocks.

In some embodiments of the present invention, a restriction on the maximum number of macroblocks in a reconstruction slice may be imposed in addition to a restriction on the size of an entropy slice.

In some embodiments of the present invention, an encoder may partition a reconstruction slice into a plurality of entropy slices, wherein the size of each entropy slice may be restricted to less than a predefined number of macroblocks and to less than a predefined number of bins.

In some embodiments of the present invention, an encoder may partition a reconstruction slice into a plurality of entropy slices, wherein the size of each entropy slice may be restricted to less than a predefined number of macroblocks and to less than a predefined number of bits.

In some embodiments of the present invention, an encoder may partition a reconstruction slice into a plurality of entropy slices, wherein the size of each entropy slice may be restricted to less than a predefined number of macroblocks, to less than a predefined number of bins and to less than a predefined number of bits.

It is to be understood that while some embodiments of the present invention may restrict the size of an entropy slice to be less than a first predefined size, that the size of the entropy slice may be equivalently restricted to not exceed a second predefined size. The embodiments described herein are exemplary embodiments of the present invention, and a person of ordinary skill in the art will appreciate that there are equivalent embodiments of the present invention for restricting the size of an entropy slice.

Table 3 shows a comparison of rate distortion performance for all-intra coding. The first comparison, shown in the two sub-columns of column three, is a comparison, using the H.264/AVC Joint Model (JM) software, version 13.0, between encoding using multiple slices, wherein entropy decoding and macroblock reconstruction for a slice does not depend on other slices, and encoding using no slices. On average, for the same bit rate, the quality is degraded by −0.3380 dB encoding using multiple slices over using no slices. On average, for the same quality level, the bit rate is increased by 7% by encoding using multiple slices over using no slices.

The second comparison, shown in the two sub-columns of column four, is a comparison between encoding using one reconstruction slice partitioned, according to embodiments of the present invention, into multiple entropy slices (two rows of macroblocks per entropy slice) and encoding using JM 13.0 with no slices. On average, for the same bit rate, the quality is degraded by −0.0860 dB using one reconstruction slice with multiple entropy slices over encoding using no slices. On average, for the same quality level, the bit rate is increased by 1.83% by encoding using one reconstruction slice with multiple entropy slices over encoding using no slices.

TABLE 3
Comparison of rate distortion performance - all-intra encoding
All Intra Coding

| | |
|---|---|
| | One |
| | reconstruction |
| | slice with multiple |
| JM 13.0 slices | entropy slices |
| compared to JM | compared to JM |
| 13.0 no slices | 13.0 no slices |

| | | BD SNR | BD Bit | BD SNR | BD Bit |
|---|---|---|---|---|---|
| Sequence | Resolution | [dB] | rate [%] | [dB] | rate [%] |
| BigShip | 720 p | −0.22 | 4.54 | −0.08 | 1.61 |
| City | 720 p | −0.28 | 4.03 | −0.06 | 0.84 |
| Crew | 720 p | −0.42 | 11.67 | −0.11 | 2.98 |
| Night | 720 p | −0.38 | 5.64 | −0.06 | 0.91 |
| ShuttleStart | 720 p | −0.39 | 9.12 | −0.12 | 2.81 |
| AVERAGE | | −0.3380 | 7.00 | −0.0860 | 1.83 |

Table 4 shows a comparison of rate distortion performance for IBBP coding. The first comparison, shown in the two sub-columns of column three, is a comparison, using the H.264/AVC Joint Model (JM) software, version 13.0, between encoding using multiple slices, wherein entropy decoding and macroblock reconstruction for a slice does not depend on other slices, and encoding using no slices. On average, for the same bit rate, the quality is degraded by −0.5460 dB encoding using multiple slices. On average, for the same quality level, the bit rate is increased by 21.41% by encoding using multiple slices over using no slices.

The second comparison, shown in the two sub-columns of column four, is a comparison between encoding using one reconstruction slice partitioned, according to embodiments of the present invention, into multiple entropy slices (two rows of macroblocks per entropy slice) and encoding using JM 13.0 with no slices. On average, for the same bit rate, the quality is degraded by −0.31 dB using one reconstruction slice with multiple entropy slices over encoding using no slices. On average, for the same quality level, the bit rate is increased by 11.45% by encoding using one reconstruction slice with multiple entropy slices over encoding using no slices.

TABLE 4
Comparison of rate distortion performance - IBBP encoding
IBBP Coding

| | |
|---|---|
| | One reconstruction |
| | slice with multiple |
| JM 13.0 slices | entropy slices |
| compared to JM | compared to JM |
| 13.0 no slices | 13.0 no slices |

| | | BD SNR | BD Bit | BD SNR | BD Bit |
|---|---|---|---|---|---|
| Sequence | Resolution | [dB] | rate [%] | [dB] | rate [%] |
| BigShip | 720 p | −0.45 | 19.34 | −0.26 | 10.68 |
| City | 720 p | −0.48 | 17.83 | −0.22 | 7.24 |
| Crew | 720 p | −0.62 | 30.10 | −0.33 | 14.93 |
| Night | 720 p | −0.36 | 11.11 | −0.19 | 5.5 |
| ShuttleStart | 720 p | −0.82 | 28.69 | −0.55 | 18.89 |
| AVERAGE | | −0.5460 | 21.41 | −0.31 | 11.45 |

Comparing the results, encoding using multiple entropy slices in one reconstruction slice provides a bit rate savings of 5.17% and 9.96% for all-intra and IBBP coding, respectively, over encoding using slices, wherein entropy decoding and macroblock reconstruction for a slice does not depend on other slices, although both allow for parallel decoding.

Table 5 shows a comparison of rate distortion performance for all-intra and IBBP coding. In this table, the comparison is a comparison between encoding using no slices and encoding using one reconstruction slice partitioned into entropy slices, according to embodiments of the present invention, of maximum size 26 k bins per entropy slice. The first comparison, shown in the two sub-columns of column two, is a comparison using all-intra coding. On average, for the same bit rate, the quality is degraded by −0.062 dB by encoding using a reconstruction slice with multiple entropy slices. On average, for the same quality level, the bit rate is increased by 1.86% by encoding using a reconstruction slice with multiple entropy slices. Thus, for all-intra coding using entropy slices of maximum size 26 k bins per entropy slice, there is an average bit rate savings of approximately 0.64% over that of fixed entropy slice sizes of two rows of macroblocks.

The second comparison, shown in the two sub-columns of column three, is a comparison using IBBP coding. On average, for the same bit rate, the quality is degraded by −0.022 dB using one reconstruction slice with multiple entropy slices over encoding using no slices. On average, for the same quality level, the bit rate is increased by 0.787% by encoding using one reconstruction slice with multiple entropy slices over encoding using no slices. Thus, for IBBP coding using entropy slices of maximum size 26 k bins per entropy slice, there is an average bit rate savings of approximately 10.66% over that of fixed entropy slice sizes of two rows of macroblocks.

TABLE 5
Comparison of rate distortion performance -
all-intra and IBBP encoding using entropy slices with less
than 26k bins per entropy slice
Entropy Slice Compared to JM 15.1 No Slice.
Experiment (1): 26k bins maximum per entropy slice

| | |
|---|---|
| All Intra | |
| Coding | IBBP Coding |

| | BD | | BD | |
|---|---|---|---|---|
| Sequence | SNR | BD Bit | SNR | BD Bit |
| (720 p) | [dB] | rate [%] | [dB] | rate [%] |
| BigShip | −0.07 | 1.40 | −0.02 | 0.70 |
| City | −0.07 | 1.02 | −0.02 | 0.51 |
| Crew | −0.05 | 1.31 | −0.03 | 1.25 |
| Night | −0.07 | 1.00 | −0.02 | 0.66 |
| ShuttleStart | −0.05 | 1.20 | −0.03 | −0.82 |
| AVERAGE | −0.062 | 1.187 | −0.022 | 0.787 |

The use of entropy slices allows for parallel decoding, and encoder partitioning of a reconstruction slice into entropy slices, wherein each entropy slice is less than a maximum number of bins may provide considerable bit rate savings over entropy slices of a fixed number of macroblocks.

The above methods can also be used on devices for encoding a video frame and decoding a video bitstream.

Some embodiments of the present invention may disclose methods in which the predefined number of bins is associated with a profile associated with a video bitstream generated by the encoder.

Some embodiments of the present invention may disclose methods in which the predefined size is associated with a profile associated with a video bitstream generated by the encoder.

Some embodiments of the present invention may disclose methods in which the predefined size is associated with a level associated with a video bitstream generated by the encoder.

Although the charts and diagrams in the Figures may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence. It is understood by those with ordinary skill in the art that software, hardware and/or firmware may be created by one of ordinary skill in the art to carry out the various logical functions described herein.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

1-25. (canceled)

26. A method for encoding a video frame of a video sequence, said method comprising:
a) in an encoder, partitioning a frame of a video sequence into at least one reconstruction slice, thereby producing a first reconstruction slice; and
b) in said encoder, partitioning said first reconstruction slice into a plurality of entropy slices, wherein the number of bins associated with each entropy slice in said plurality of entropy slices is less than or equal to a predefined number of bins.

27. The method as described in claim 26, wherein the number of macroblocks associated with said first reconstruction slice is less than or equal to a predefined number of macroblocks.

28. The method as described in claim 26, wherein the number of macroblocks associated with each entropy slice in said plurality of entropy slices is less than or equal to a predefined number of macroblocks.

29. The method as described in claim 26, wherein the number of bits associated with each entropy slice in said plurality of entropy slices is less than or equal to a predefined number of bits.

30. The method as described in claim 29, wherein the number of macroblocks associated with each entropy slice in said plurality of entropy slices is less than or equal to a predefined number of macroblocks.

31. The method as described in claim 26, wherein said predefined number of bins is associated with a level conformance point associated with a video bitstream generated by said encoder.

32. The method as described in claim 26, wherein said predefined number of bins depends on at least one parameter selected from the group consisting of bit rate, image size and total number of macroblocks.

33. The method as described in claim 26 further comprising associating an entropy-slice header with each entropy slice in said plurality of entropy slices.

34. The method as described in claim 26 further comprising associating an entropy-slice flag with a bitstream generated using said plurality of entropy slices.

35. A method for encoding a video frame of a video sequence, said method comprising:
a) in an encoder, partitioning a frame of a video sequence into at least one reconstruction slice, thereby producing a first reconstruction slice; and
b) in said encoder, partitioning said first reconstruction slice into a plurality of entropy slices, wherein the size of each entropy slice in said plurality of entropy slices is smaller than or equal to a predefined size, wherein said predefined size is related to number of bits or number of macroblocks.

36. The method as described in claim 35, wherein the number of macroblocks associated with said first reconstruction slice is less than or equal to a predefined number of macroblocks.

37. The method as described in claim 35, wherein said predefined size is associated with a level conformance point associated with a video bitstream generated by said encoder.

38. The method as described in claim 35, wherein said predefined size depends on at least one parameter selected from the group consisting of bit rate, image size and total number of macroblocks.

39. The method as described in claim 35 further comprising associating an entropy-slice header with each entropy slice in said plurality of entropy slices.

40. The method as described in claim 35 further comprising associating an entropy-slice flag with a bitstream generated using said plurality of entropy slices

41. A method for generating a video bitstream for parallel decoding, said method comprising:
a) receiving, at a decoder, a first video bitstream;
b) identifying a reconstruction slice in said video bitstream;
c) entropy decoding a plurality of symbols from said reconstruction slice, thereby producing entropy-decoded data associated with said reconstruction slice;
d) partitioning said entropy-decoded data associated with said reconstruction slice into a plurality of entropy slices associated with said reconstruction slice, wherein the number of bins associated with each entropy slice in said plurality of entropy slices is less than or equal to a predefined number of bins;
e) independently entropy encoding the entropy-decoded data of each entropy slice of said plurality of entropy slices, thereby producing a plurality of entropy-encoded entropy slices; and
f) generating a second video bitstream comprising said plurality of entropy-encoded entropy slices.

42. A method for decoding a video bitstream, said method comprising decoding a plurality of entropy slices associated with a reconstruction slice, wherein the number of bins associated with each entropy slice in said plurality of entropy slices is less than or equal to a predefined number of bins.

43. The method as described in claim 42, wherein said predefined number of bins is associated with a level conformance point associated with said video bitstream.

44. A method for generating a video bitstream for parallel decoding, said method comprising:
a) receiving, at a decoder, a first video bitstream;
b) identifying a reconstruction slice in said video bitstream;
c) entropy decoding a plurality of symbols from said reconstruction slice, thereby producing entropy-decoded data associated with said reconstruction slice;
d) partitioning said entropy-decoded data associated with said reconstruction slice into a plurality of entropy slices associated with said reconstruction slice, wherein the size of each entropy slice in said plurality of entropy slices is smaller than or equal to a predefined size, wherein said predefined size is related to number of bits or number of macroblocks;
e) independently entropy encoding the entropy-decoded data of each entropy slice of said plurality of entropy slices, thereby producing a plurality of entropy-encoded entropy slices; and
f) generating a second video bitstream comprising said plurality of entropy-encoded entropy slices.

45. A method for decoding a video bitstream, said method comprising decoding a plurality of entropy slices associated with a reconstruction slice, wherein the size of each entropy slice in said plurality of entropy slices is smaller than or equal to a predefined size, wherein said predefined size is related to numbers of bits or number of macroblocks.

46. The method as described in claim 45, wherein said predefined size is associated with a level conformance point associated with said video bitstream.

47. The method as described in claim 31 further comprising indicating said predefined number of bins for each level conformance point of said encoder according to a table.

48. The method as described in claim 37 further comprising indicating said predefined size for each level conformance point of said encoder according to a table.

49. The method as described in claim 26, wherein the number of bins associated with said first reconstruction slice is less than or equal to a predefined number of bins.

50. The method as described in claim 26, wherein the number of bits associated with said first reconstruction slice is less than or equal to a predefined number of bits.
